(19) United States
(12) Patent Application Publication
(10) Pub. No.: US 2012/0124888 A1
(43) Pub. Date: May 24, 2012

(54) Affix-a-Tick Tick Trap

(76) Inventor: Thomas Matthew Lemberg, Stockbridge, GA (US)

(21) Appl. No.: 12/948,920

(22) Filed: Nov. 18, 2010

(51) Int. Cl. A01M 1/14; A01M 1/10

(52) U.S. Cl. 43/107; 43/114; 43/121

(57) ABSTRACT

A tick trap comprising of a thin wire placed into the ground with a sticky surface to trap ticks and a plastic sheath protecting wire with an attractant placed within the tip to attract ticks to the trap.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

This invention relates to a trap designed for the purpose of trapping and removing ticks from areas where ticks are, or can become, a problem.

As carriers of several debilitating diseases, ticks are dangerous parasites when left untreated in areas prone to human activities. The primary response to treat areas with large tick infestations is by using insecticide sprays which decimate whole ecosystems of insects. This response will eliminate the ticks, but it will also remove beneficial insects that keep the parasitic insects under control. After sprays have been used, the first populations to return are the parasitic populations that are the root reasoning for the insecticide sprays. The act of spraying for parasitic insects makes future applications of insecticides required since the parasite populations will no longer have predator insects to control their populations. Targeting the parasitic insects while leaving the beneficial insects unharmed will reduce the parasite population and allow for the beneficial insects to continue to further reduce these same parasites.

Additional avenues of tick control are either more expensive, more intrusive, or both. The use of dry ice traps is effective, but difficult to use by most persons as these are relegated to home remedies and include large items that would be disposed of into landfills. The use of chickens or guinea fowls, long considered as the most effective way of clearing large areas, is only available to rural areas since it is typically regulated within subdivisions and sub-urban and urban settings.

Other traps are not easily produced or at a low enough cost per unit to entice typical persons to use them, therefore these are not readily available. It was this lack of available traps that lead to the necessity of this invention.

### BRIEF SUMMARY OF THE INVENTION

This invention is a tick trap comprising of a thin wire placed into the ground with a sticky surface to trap ticks and a plastic sheath protecting wire with an attractant placed within the tip to attract ticks to the trap.

The object of this invention is to provide a unique, simple, and easily produced and distributed tick trap that works in concert with the tick's natural propensity to climb grasses as a way to ambush host animals, while reducing the need for chemical insecticide sprays for tick control.

### BRIEF DESCRIPTION OF THE DRAWINGS

The trap is best described through drawings and explained further as follows:

FIG. 1: is an elevation view of the tick trap, and

FIG. 2: is a section through the center of the trap.

### DETAILED DESCRIPTION OF THE INVENTION

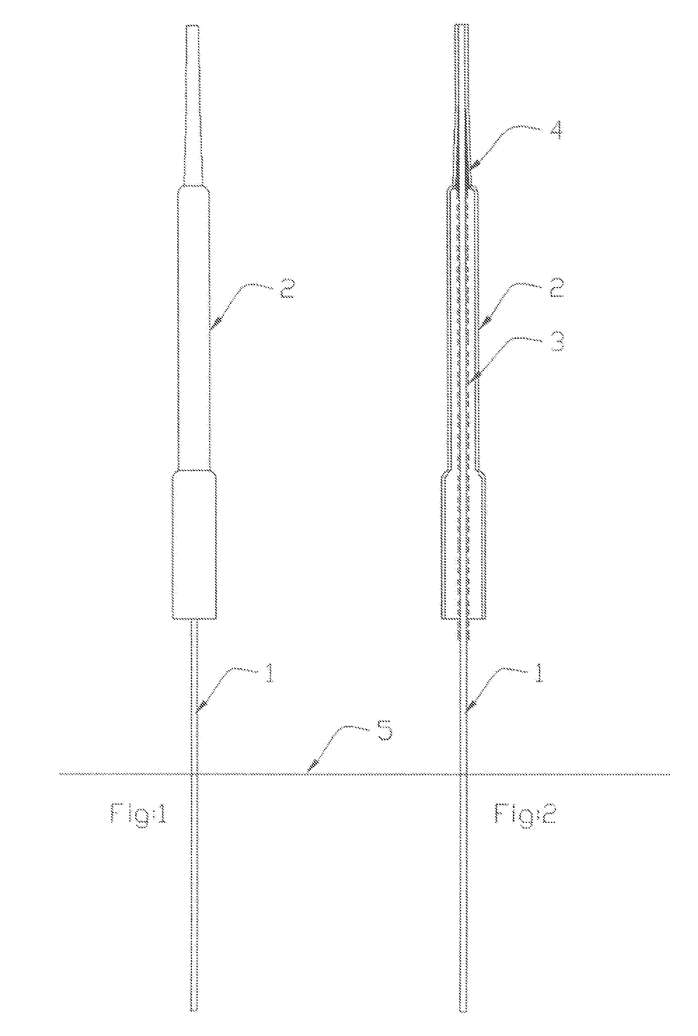

Referring now to FIG. 1 of the drawings, the invention comprises a tick trap which includes a wire (1) to be placed into the earth (5) and protected from the elements by a plastic sheath (2).

Referring now to FIG. 2 of the drawings, the invention includes a sticky surface (3) applied to the wire (1) within the sheath (2). Within the sheath (2) is placed a tick attractant (4).

The ticks will be attracted to the attractant (4) and once at the trap will be naturally drawn to climb the wire (1) as is natural for ticks in ambushing host animals. Once the tick climbs the wire (1) it will be trapped on the sticky surface (3) where it can be removed or die of starvation.

Use of this trap will be simple and easily accomplished by most persons. Once placed, the trap has no moving parts and may remain in one location for any length of time as desired with no need to further interact with the ticks to destroy the same. The sheath protects the sticky layer from the elements and dirt contamination prolonging the effective life cycle of the trap.

Having been explained in detail, it is understood that the components of the trap may be modified or substituted may be made within the scope of the claims where the intent is to include equivalents of such embodiments. The composition of this trap is new and assembled from various parts that are manufactured by others for purposes other than that which is proposed and described.

What is claimed is:

1. A tick trap comprised of a central wire coated with a sticky substance to be placed in the earth.

2. A tick trap in accordance with claim 1 wherein: the wire is protected with a plastic sheath.
